(19) United States
(12) Patent Application Publication
(10) Pub. No.: US 2013/0250725 A1
(43) Pub. Date: Sep. 26, 2013

(54) RETRIEVABLE VERTICAL GEOPHONE CABLE AND METHOD

(71) Applicant: CGGVERITAS SERVICES SA, Massy Cedex (FR)

(72) Inventor: Julien MEUNIER, Paris (FR)

(73) Assignee: CGGVERITAS SERVICES SA, Massy Cedex (FR)

(21) Appl. No.: 13/845,669

(22) Filed: Mar. 18, 2013

Related U.S. Application Data
(60) Provisional application No. 61/614,686, filed on Mar. 23, 2012.

(51) Int. Cl. G01V 1/16

(52) U.S. Cl. CPC G01V 1/16; G01V 1/168
USPC 367/57

(57) ABSTRACT

A method and a retrievable vertical geophone cable for collecting seismic data underground. The retrievable vertical geophone cable includes an envelope having a first end at which a connector mechanism is provided to close the envelope; plural geophones distributed inside the envelope at predetermined positions; and a first expansion mechanism attached to a geophone of the plural geophones and configured to expand the envelope when actuated with a first fluid under pressure.

### BACKGROUND

1. Technical Field

Embodiments of the subject matter disclosed herein generally relate to methods and systems for collecting seismic data using a vertical geophone cable and, more particularly, to mechanisms and techniques for increasing a coupling of the geophones from a vertical geophone cable to the ground.

2. Discussion of the Background

Land seismic data acquisition and processing may be used to generate a profile (image) of the geophysical structure under the ground (subsurface). While this profile does not provide an accurate location for oil and gas reservoirs, it suggests, to those trained in the field, the presence or absence of such reservoirs. Thus, providing a high-resolution image of the subsurface is important, for example, to those who need to determine where oil and gas reservoirs are located.

Traditionally, as illustrated in FIG. 1, a land seismic survey 100 that uses vertical geophone cables is performed in the following way. Plural geophones 102 are electrically connected to a recorder along a cable 104. A well 106 is dug into the ground 108 to accommodate the plural geophones.

After all the geophones have been deployed, one or more seismic sources are brought into the field and actuated to generate the seismic waves. The seismic waves propagate through the ground until they are reflected by various reflectors. The reflected waves propagate to the geophones, where a movement of the earth is recorded. However, if the coupling between the geophone and the dirt around the geophone is not good, the recorded data is of low quality.

A geophone typically has a cylindrical shape and a small size, e.g., around 3 cm long and 2 cm in diameter. Thus, a coupling between the geophone and the well might be a problem when their diameters are very different. The coupling is improved if the diameter of the geophone is close to the diameter of the well. However, the coupling between the ground and geophone is not well understood. The geophone-ground coupling may be defined as the difference between the velocity measured by the geophone and the velocity of the ground without the geophone. This definition is appropriate for designing a geophone.

However, once the geophone is designed and needs to be deployed, the practicing geophysicist has to deal with the fact that the geophone may not be appropriately deployed. For example, the geophone may not be “well” coupled to its surroundings. In this situation, the above definition might not be appropriate. For this situation, those skilled in the art would consider that a “bad” geophone coupling refers to a difference between the velocity as measured by the badly-planted geophone and the velocity as measured by the well-planted geophone.

Irrespective of the definition to be used, the ground-geophone coupling is a persistent problem in the art because it is problematic to make the casing of the geophone to tightly contact the well and, at the same time, to ensure that the geophones are easily retrievable from the well when desired. One method known in the industry is to attach a cable 110 with a high mechanical resistance to the casing of each geophone and, when the time arrives to remove the geophones, to pull this cable up to retrieve the geophones. However, if a portion of the well has collapsed at the location of one geophone, that geophone may be stuck at that position and even pulling the cable 110 may not retrieve that geophone.

Therefore, there is a need to improve the coupling of the geophone to the ground and at the same time to make easier and safer the process of retrieving the geophones.

### SUMMARY OF THE INVENTION

According to an exemplary embodiment, there is a retrievable vertical geophone cable for collecting seismic data underground. The retrievable vertical geophone cable includes an envelope having a first end at which a connector mechanism is provided to close the envelope, plural geophones distributed inside the envelope at predetermined positions, and a first expansion mechanism attached to a geophone of the plural geophones and configured to expand the envelope when actuated with a first fluid under pressure.

According to another exemplary embodiment, there is a retrievable vertical geophone cable for collecting seismic data underground. The retrievable vertical geophone cable includes an envelope, a geophone provided inside the envelope at a predetermined position, and an expansion mechanism attached to the geophone and configured to expand the envelope when actuated with a first fluid under pressure.

According to still another exemplary embodiment, there is a method for deploying a retrievable vertical geophone cable for collecting seismic data. The method includes a step of deploying the retrievable vertical geophone cable inside a well that has an inner diameter (d2) larger than an outer diameter (d1) of an envelope of the retrievable vertical geophone cable; a step of actuating an expansion mechanism, attached to a geophone of the retrievable vertical geophone cable, so that the envelope is pressed against the well; and a step of collecting the seismic data with the geophone.

### BRIEF DESCRIPTION OF THE DRAWINGS

For a more complete understanding of the present invention, reference is now made to the following descriptions taken in conjunction with the accompanying drawings, in which:

FIG. 1 illustrates a vertical arrangement of geophones deployed in a well;

FIG. 2 is a schematic diagram of a retrievable vertical geophone cable according to an exemplary embodiment;

FIG. 3 is a schematic diagram of an expansion mechanism according to an exemplary embodiment;

FIG. 4 is a longitudinal cross-section of a geophone and associated expansion mechanism according to an exemplary embodiment;

FIG. 5 is a transversal cross-section of a geophone and associated expansion mechanism according to an exemplary embodiment;

FIG. 6 illustrates a retrievable vertical geophone cable deployed in a well according to an exemplary embodiment;

FIG. 7 is a flowchart of a method for deploying a retrievable vertical geophone cable in a well according to an exemplary embodiment;

FIG. 8 is a schematic diagram of horizontally deployed geophones; and

FIG. 9 is a schematic diagram of vertically deployed geophones according to an exemplary embodiment.

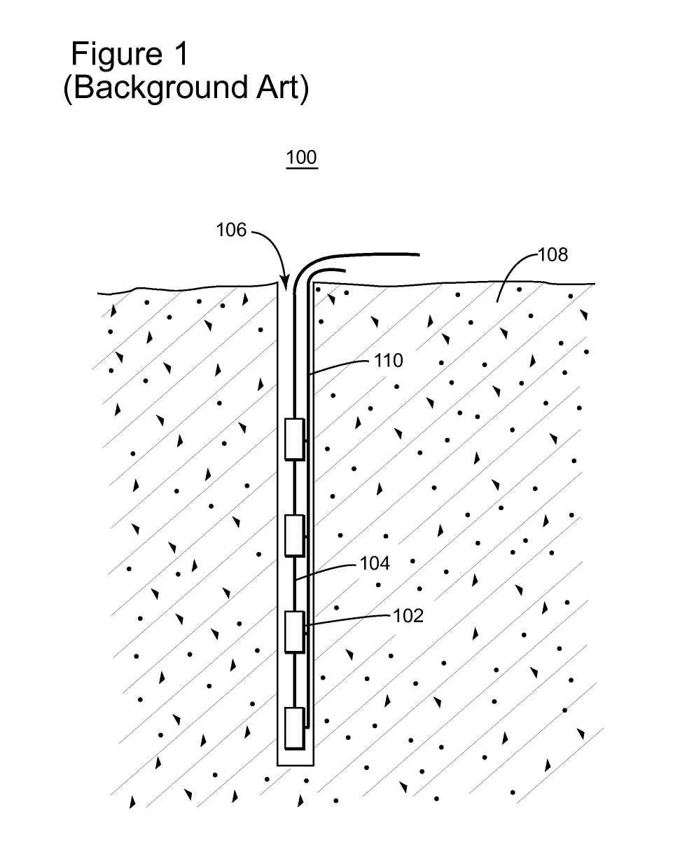

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a retrievable vertical geophone cable. However, the embodiments to be discussed next are not limited to a vertical geophone cable but may be applied to slanted and/or horizontal cables.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment, there is a retrievable vertical geophone cable for collecting seismic data underground. The retrievable vertical geophone cable includes an envelope, a geophone provided inside the envelope at a predetermined position, and an expansion mechanism attached to the geophone and configured to expand the envelope to increase the coupling between the envelope and the well.

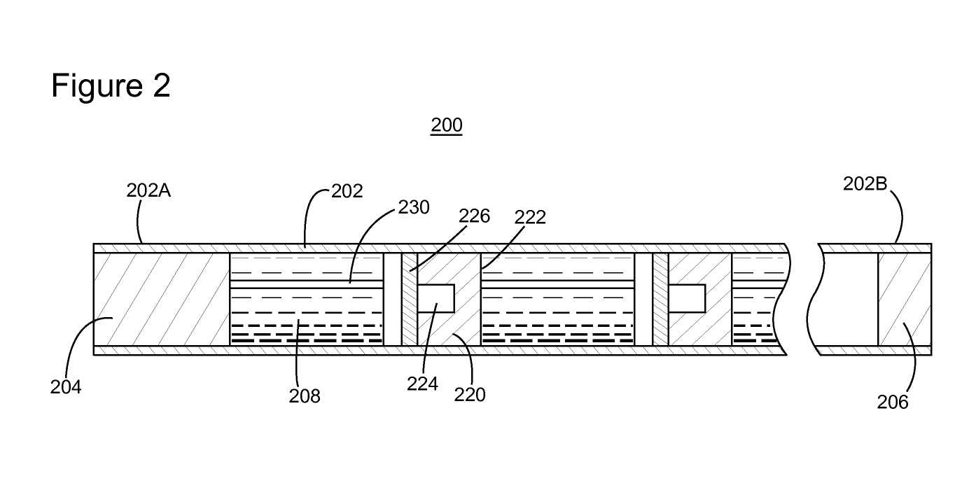

According to an exemplary embodiment illustrated in FIG. 2, a retrievable vertical geophone cable 200 includes an envelope 202 that has, at one end 202A, a connector mechanism 204 and, at the other end 202B, a cap 206 so that a fluid 208 provided inside the envelope 202 does not leak to the ambient. Further, the connector mechanism 204 and the cap 206 are so configured that the fluid does not leak outside the vertical geophone cable when the fluid is pressurized. In the following, it is noted that the term “vertical” means that an angle formed between the geophone cable 200 and gravity is smaller than a few degrees, e.g., smaller than 10 degrees.

The envelope 202 further includes a geophone 220 and, preferably, a plurality of them. A hydraulic hose 230 connects the connector mechanism 204 to each of the geophones 220. A geophone 220 includes a casing 222, inside which is provided a geophone sensor 224. Further, the geophone 220 may include an expansion mechanism 226 connected to the hydraulic hose 230, and the expansion mechanism 226 is configured to expand inside the envelope 202 so that the envelope 202 increases its diameter (i.e., its volume). Thus, the envelope 202 is made of a flexible material, for example, polyurethane.

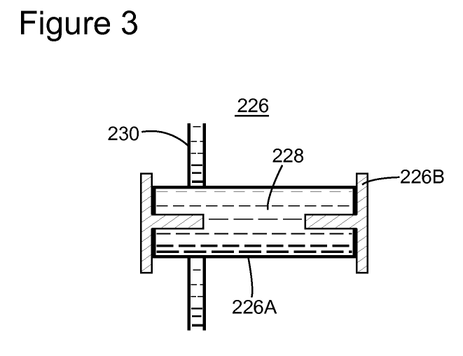

The expansion mechanism 226 may be a jack having a casing 226A and two or more pistons 226B as illustrated in FIG. 3. A fluid 228 under pressure may be provided through the hydraulic hose 230 to the casing 226A to activate the pistons 226B. The fluid 228 may be identical or different from the fluid 208 that is present among the geophones. The fluid 228 may be a bio-degradable oil, a mineral oil, water, etc. The expansion mechanism 226 may be provided at one end of the geophone sensor 224 as shown in FIG. 2 or at both ends of the geophone sensor 224.

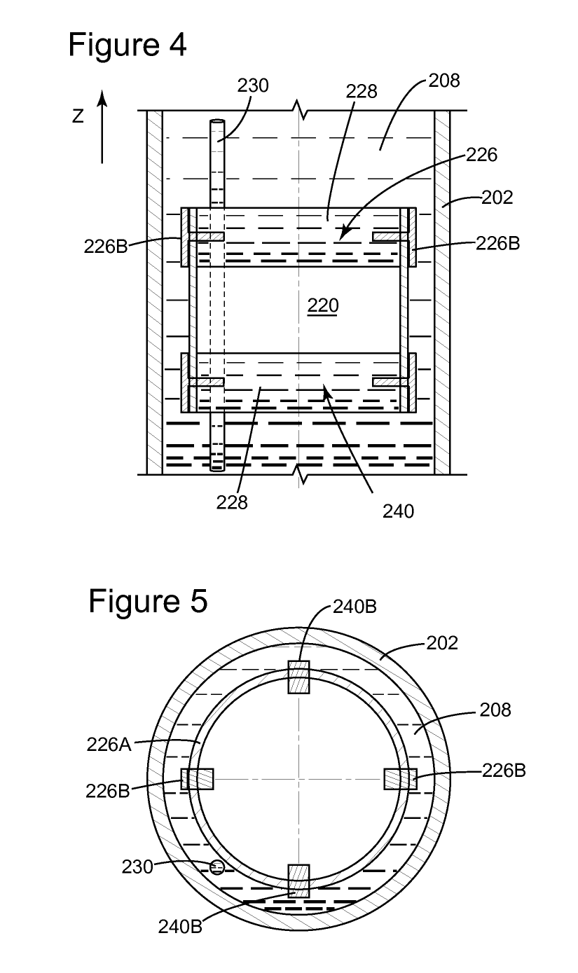

Closer views of a single geophone 220 of the retrievable vertical geophone cable 200 are shown in FIGS. 4 and 5. FIG. 4 shows a longitudinal cross-section through the envelope 202, the geophone 220 and two expansion mechanisms 226 and 240. The first expansion mechanism is provided at the top of the geophone 220, and the second expansion mechanism 240 is provided at the bottom of the geophone 220. FIG. 5 is a transversal cross-section of the above devices and shows that the pistons 226B of the first expansion mechanism 226 are offset (at 90 degrees in FIG. 5) relative to pistons 240B of the second expansion mechanism 240. In one application, pistons of different expansion mechanisms maybe aligned or provided at other angles than 90 degrees.

One purpose of the expansion mechanisms is to ensure better contact between the envelope (and consequently the geophone) and the walls of the well. This is explained next while also explaining how the retrievable vertical geophone cable is deployed and retrieved from a well.

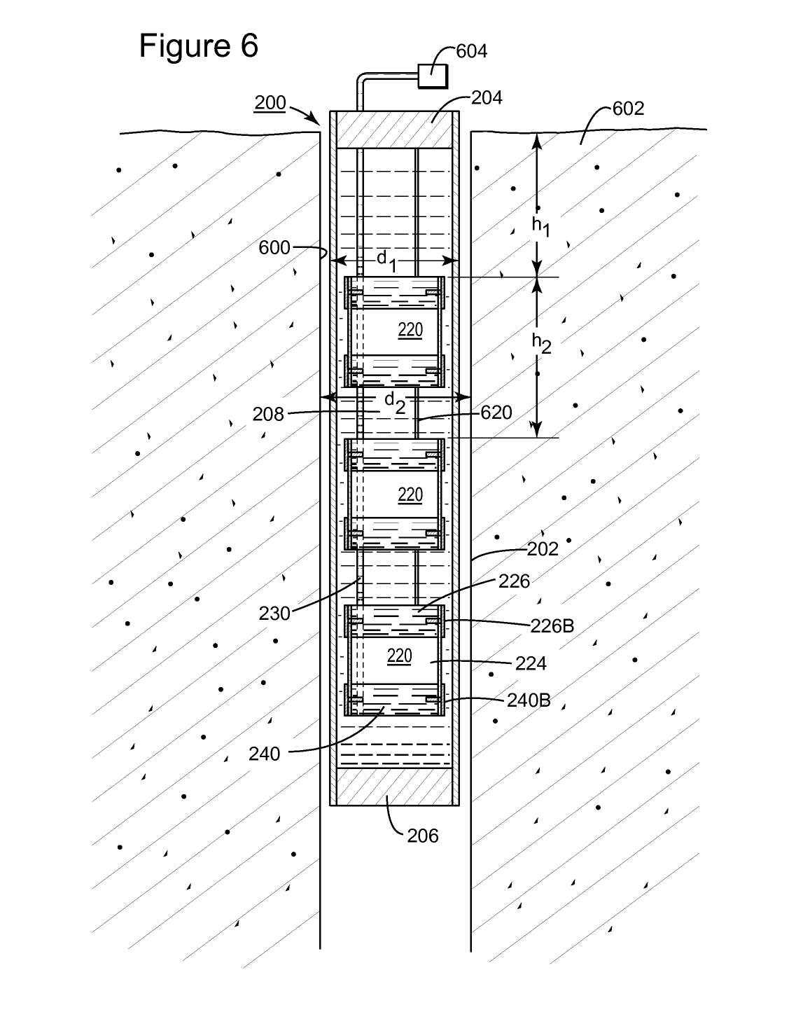

Consider, as shown in FIG. 6, that a well 600 has been formed in the ground 602. The retrievable vertical geophone cable 200 is then inserted into the well 600. The external diameter d1 of the retrievable vertical geophone cable 200, i.e., an external diameter of the envelope 202, is slightly smaller than the internal diameter d2 of the well 600. This is so for easily deploying the retrievable vertical geophone cable 200 inside the well 600. Once the retrievable vertical geophone cable 200 is in place, the gap between the envelope 202 and the walls of the well 600 are reduced by providing the fluid 228 under pressure to the expansion mechanisms 226 and 240. As a result of this action, the pistons 226B and 240B expand, pressing the envelope 202 against the well 600.

Further, the fluid 208 may be pressurized (with a pressure smaller than a pressure of the fluid 228) to maintain the increased volume of the envelope 202. In this way (i.e., having a pressure difference between the fluid 228 and 208), the coupling between the geophone sensor 224 and the well 600 is improved. The pressurized fluid 228 may be provided from a pump 604 connected to the connector mechanism 204. The same pump or another pump may provide the extra pressure to the fluid 208. The connector mechanism 204 may be directly connected to the pump 604 or together with similar connector mechanisms from other retrievable vertical geophone cables.

It is noted that, when in use, the fluid 228 is under a pressure higher than the pressure of the fluid 208. In one application, the fluid 208 does not communicate with the fluid 228. The fluid 208 is trapped inside the envelope, and it is supposed to not escape into the ambient of the envelope. In the event that the integrity of the envelope is compromised, if the fluid 208 is a bio-degradable oil or water, there is minimal impact to the environment.

Seismic data from the geophones is collected through an electrical cable 620. This cable connects each geophone to the connector mechanism 204. Thus, the connector mechanism 204 is an electric and hydraulic connector. A distance h1 between the connector mechanism 204 and the first geophone may be about 2 to 4 m, and a distance h2 between the geophones may be about 1.5 to 3 m. Other distances may be used, depending on the application. The retrievable vertical geophone cable 200 may include any number of geophones.

After the seismic survey has been completed, to remove the retrievable vertical geophone cable 200 from the well, the fluid 228 is released or its pressure is decreased (in one application, the pressure of fluid 208 needs to be also decreased. In still another application, e.g., marsh, water or air needs to be flush around the cable to retrieve it), so that the pistons of the expansion mechanisms 226 and 240 are retracted and the envelope is slightly deflated (i.e., its volume is reduced) to not be under tight contact with the walls of the well 600. Further, part of the fluid 208 is released from the envelope to accommodate its volume change. In this way, the retrievable vertical geophone cable 200 can easily be retrieved from the well.

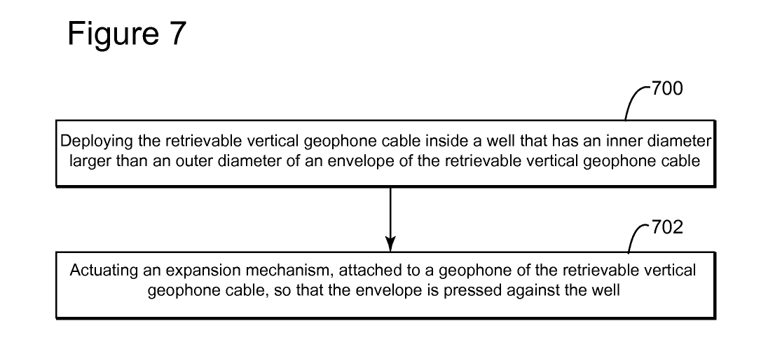

The above process may be summarized based on the flowchart shown in FIG. 7 as follows. FIG. 7 illustrates a method for deploying a retrievable vertical geophone cable for collecting seismic data. The method includes a step 700 of deploying the retrievable vertical geophone cable inside a well that has an inner diameter (d2) larger than the outer diameter (d1) of an envelope of the retrievable vertical geophone cable, and a step 702 of actuating an expansion mechanism, attached to a geophone of the retrievable vertical geophone cable, so that the envelope is pressed against the well. The method may optionally include a step of pumping a second fluid inside the envelope, among the geophones, for increasing the volume of the envelope. Further, the method may also include a step of collecting the seismic data, a step of reducing the volume of the envelope and a step of removing the vertical geophone cable from the well.

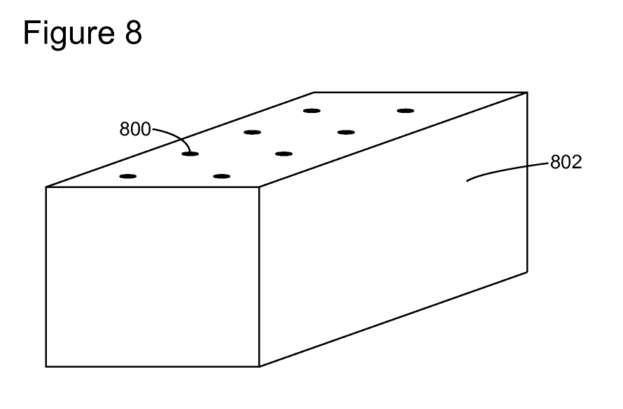

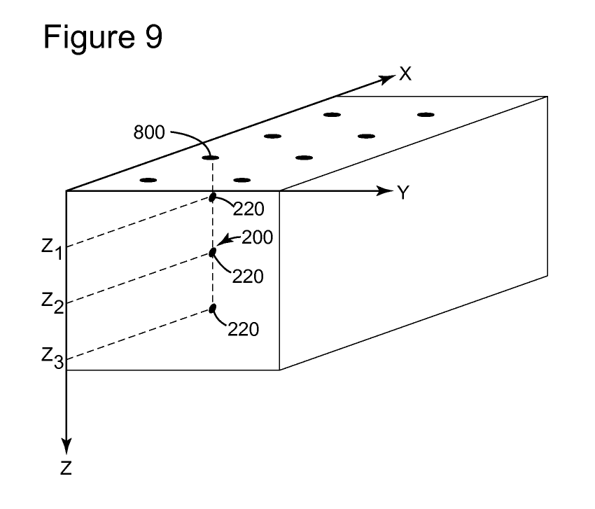

It is noted that the retrievable vertical geophone cable is intended to replace traditional geophones 800 that are deployed, in a horizontal manner, above or below ground 802 as illustrated in FIG. 8. In this way, instead of having a single geophone 800 at a given X and Y position, a string of geophones (cable 200) are deployed at the same X and Y position, as shown in FIG. 9, each geophone 220 having a different depth Z. In this way, it is expected, besides a better coupling, to eliminate horizontal filtering which currently reduces the noise but damages the signal, and/or to record the seismic data in a quieter environment, and/or to take profit of some Rayleigh wave properties to separate these waves from the recorded signal (body waves).

The disclosed exemplary embodiments provide a method and a retrievable vertical geophone cable. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A retrievable vertical geophone cable for collecting seismic data underground, the retrievable vertical geophone cable comprising:
an envelope having a first end at which a connector mechanism is provided to close the envelope;
plural geophones distributed inside the envelope at predetermined positions; and
a first expansion mechanism attached to a geophone of the plural geophones and configured to expand the envelope when actuated with a first fluid under pressure.

2. The retrievable vertical geophone cable of claim 1, further comprising:
a hydraulic connector connected between the connector mechanism and the geophone and configured to provide the first fluid under pressure to the first expansion mechanism to actuate the first expansion mechanism.

3. The retrievable vertical geophone cable of claim 2, wherein the first expansion mechanism includes at least two pistons that are actuated by the first fluid.

4. The retrievable vertical geophone cable of claim 1, further comprising:
a second expansion mechanism attached to the geophone and configured to expand the envelope.

5. The retrievable vertical geophone cable of claim 4, wherein pistons of the first expansion mechanism are offset by a predetermined angle relative to pistons of the second expansion mechanism, in a transversal cross-section of the envelope.

6. The retrievable vertical geophone cable of claim 1, wherein a space inside the envelope, among adjacent geophones, is filed with a second fluid.

7. The retrievable vertical geophone cable of claim 6, wherein a pressure of the first fluid is higher than a pressure of the second fluid.

8. The retrievable vertical geophone cable of claim 6, wherein the first fluid and the second fluid are bio-degradable oil.

9. The retrievable vertical geophone cable of claim 1, further comprising:
a cap provided at a second end of the envelope so that a second fluid provided around the geophones is pressurized without escaping outside the envelope.

10. The retrievable vertical geophone cable of claim 1, wherein the envelope is flexible so that its volume increases when the first fluid is pressurized.

11. The retrievable vertical geophone cable of claim 1, wherein the envelope is configured to enter inside a well extending through the ground.

12. The retrievable vertical geophone cable of claim 11, wherein the envelope contacts a wall of the well and cannot be retrieved from the well when the first expansion mechanism is activated.

13. A retrievable vertical geophone cable for collecting seismic data underground, the retrievable vertical geophone cable comprising:
an envelope;
a geophone provided inside the envelope at a predetermined position; and
an expansion mechanism attached to the geophone and configured to expand the envelope when actuated with a first fluid under pressure.

14. The retrievable vertical geophone cable of claim 13, further comprising:
a hydraulic connector connected to the geophone and configured to provide the first fluid under pressure to the expansion mechanism to actuate the expansion mechanism.

15. The retrievable vertical geophone cable of claim 14, wherein the expansion mechanism includes at least two pistons that are actuated by the first fluid.

16. The retrievable vertical geophone cable of claim 13, wherein a space inside the envelope, among adjacent geophones, is filed with a second fluid.

17. The retrievable vertical geophone cable of claim 16, wherein a pressure of the first fluid is higher than a pressure of the second fluid.

18. The retrievable vertical geophone cable of claim 16, wherein the first fluid and the second fluid are bio-degradable oil.

19. A method for deploying a retrievable vertical geophone cable for collecting seismic data, the method comprising:
deploying the retrievable vertical geophone cable inside a well that has an inner diameter (d2) larger than an outer diameter (d1) of an envelope of the retrievable vertical geophone cable;
actuating an expansion mechanism, attached to a geophone of the retrievable vertical geophone cable, so that the envelope is pressed against the well; and
collecting the seismic data with the geophone.

20. The method of claim 19, further comprising:
de-actuating the expansion mechanism to reduce a volume of the envelope; and
retrieving at the surface the retrievable vertical geophone cable.
